(19) United States
(12) Patent Application Publication
(10) Pub. No.: US 2026/0039565 A1
(43) Pub. Date: Feb. 5, 2026

(54) DEVICES, METHODS AND COMPUTER-READABLE MEDIA FOR ACTIVATION OF ARTIFICIAL INTELLIGENCE AND/OR MACHINE LEARNING CAPABILITIES

(71) Applicant: Nokia Technologies Oy, Espoo (FI)

(72) Inventors: Borislava GAJIC, Munich (DE); Stephen MWANJE, Munich (DE); Dario BEGA, Stuttgart (DE)

(21) Appl. No.: 19/099,439

(22) PCT Filed: Aug. 4, 2022
(86) PCT No.: PCT/EP2022/071941

§ 371 Date: Jan. 28, 2025

(51) Int. Cl. H04L 41/16; H04W 8/22; H04W 24/02

(52) U.S. Cl. CPC H04L 41/16; H04W 8/22; H04W 24/02

(57) ABSTRACT

A disclosed aspect concerns a network device (101) comprising at least one processor (510), at least one memory (520) including computer program code (570), the at least one memory and computer program code configured to, with the at least one processor, cause the network device at least to perform: obtaining (201) information descriptive of a capability of a network entity (103) of another network device (102), said network entity comprising a capability for providing an output based on an artificial intelligence and/or machine learning inference function related to one or more network objects or object types; sending (203, 404), to the other network device, a request for a partial activation of the capability. Other aspects concern the other network device, methods respectively associated with each network devices and computer-readable media storing appropriate computer program code.

### TECHNICAL FIELD

Various example embodiments relate to devices, methods, and computer-readable media for the activation of artificial intelligence and/or machine learning capabilities.

### BACKGROUND

Artificial Intelligence (AI) and Machine Learning (ML) techniques are being increasingly employed in 5G systems and will find wide application in future systems such as 6G. AI/ML techniques have been proposed for implementing network data analytics functions such as ‘NWDAF’ in 3GPP 5G cores and management data analytics services (‘MDAS’) in 3GPP Operation, Administration and Management (‘OAM’).

The technical specification 3GPP TS 28.105, V17.0.0 dated Jun. 15, 2022 specifies AI/ML management related capabilities and services focusing mainly on AI/ML training. The technical report 3GPP TR 28.908, currently being drafted, aims at discussing the use cases, potential requirements and possible solutions for management of further AI/ML capabilities such as AI/ML validation, testing, deployment, configuration and performance evaluation.

The present disclosure proposes a flexible approach for activation of AI/ML capabilities.

### SUMMARY

The scope of protection is set out by the independent claims. The embodiments, examples, and features, if any, described in this specification that do not fall under the scope of the protection are to be interpreted as examples useful for understanding the various embodiments and examples that fall under the scope of protection.

According to a first aspect, there is provided a method carried out by a first network device comprising at least one processor and at least one memory comprising computer program code which when executed by said at least one processor causes the device to perform the method, the method comprising:
obtaining information descriptive of a capability of a network entity of a second network device, said network entity comprising a capability for providing an output based on an artificial intelligence and/or machine learning inference function related to one or more network objects or object types;
sending, to the second network device, a request for partial activation of the capability.

According to one or more embodiments, the method comprises obtaining information descriptive of a plurality of predefined ordered activation levels identifying gradually increasing capability activation scopes; and wherein the request describes the partial activation scope by reference to one of said predefined activation levels.

According to one or more embodiments, the method comprises receiving, from the second device, information descriptive of a status of the activation scope of the capability in response to the request.

According to one or more embodiments, the information descriptive of the capability comprises one or more among the following items:
a. one or more objects and/or object types for which the network entity is configured to undertake optimization or control;
b. one or more parameters of the one or more objects and/or object types which the network entity is configured to control or optimize to achieve desired results;
c. one or more network metrics which the network entity is configured to seek improvement of;
d. one or more network characteristics related to the one or more objects and/or object types.

According to one or more embodiments, the request comprises one or more subsets of at least one of the items a to d for describing the partial scope of activation.

According to one or more embodiments, the request comprises at least one among a network context and an artificial intelligence and/or machine learning context for describing the partial activation scope.

According to one or more embodiments, the method comprises determining if data descriptive of a performance of the capability further to the activation of the capability at the requested activation scope meets a performance criterion, and in the affirmative, sending a request for an increase of the previously requested activation scope to the second device.

According to one or more embodiments, the method comprises requesting an increase of the scope of activation of the capability only if a full scope of activation has not yet been reached.

According to one or more embodiments, the method comprises
if the criterion is not met, sending a request for deactivation to the second device identifying one of:
an instruction to undo the activation request;
a complete deactivation of the capability;
a reduced scope of activation to be achieved compared to the scope of activation for which the criterion was not met;
one or more active parts of the activation scope of the capability that are to be deactivated;
a level among the plurality of predefined ordered activation levels identifying gradually increasing capability activation scopes.

According to one or more embodiments, the method comprises determining network performance degradation and requesting a partial decrease in capability activation scope responsive to said determining.

According to one or more embodiments, the method comprises obtaining from the second network device at least one of an accuracy measurement or data descriptive of a benefit evaluation carried out by said second device, wherein said accuracy measurement or data descriptive of a benefit evaluation are function of an output of said capability for an envisioned partial activation scope without application of said output to an operational network environment and sending said request for partial activation as a function of the at least one of an accuracy measurement or data descriptive of a benefit evaluation.

According to a second aspect, there is provided a method carried out by a second network device comprising at least one processor and at least one memory comprising computer program code which when executed by said at least one processor causes the device to perform the method, the second network device comprising a network entity, the network entity comprising a capability for providing an output based on an artificial intelligence and/or machine learning inference function related to one or more network objects or object types, the method comprising partial activation of the capability.

According to one or more embodiments, the method comprises making available, to other network devices, information descriptive of the capability.

According to one or more embodiments, the method comprises making available, to other network devices, information descriptive of a plurality of predefined ordered activation levels identifying gradually increasing capability activation scopes within the available scope.

According to one or more embodiments, the method comprises making available, to other network devices, at least one of an accuracy measurement or data descriptive of a benefit evaluation carried out by the second device, wherein said accuracy measurement or data descriptive of a benefit evaluation is function of an output of said capability for an envisioned change in activation scope without application of said output to an operational environment.

According to one or more embodiments, the information descriptive of the capability comprises one or more among the following items:
a. one or more objects and/or object types for which the network entity is configured to undertake optimization or control;
b. one or more parameters of the one or more objects and/or object types which the network entity is configured to control or optimize to achieve desired results;
c. one or more network metrics which the network entity is configured to seek improvement of;
d. one or more network characteristics related to the one or more objects and/or object types.

According to one or more embodiments, partial activation of the capability is performed in response to a request for partial activation from a first network device.

According to one or more embodiments, the method comprises after activation of the capability at the requested scope, sending, to the first device, status information descriptive of an activation status of the capability with regard to the requested scope.

According to one or more embodiments, the method comprises receiving, in the request, at least one among a network context and an artificial intelligence and/or
machine learning context; and
responsive to the context, limiting the scope of activation of the capability.

According to one or more embodiments, the method comprises determining network performance degradation and partially decreasing the capability activation scope responsive to said determining.

According to one or more embodiments, activation of the capability comprises application of an output of the capability to an operational network environment.

A third aspect concerns a network device comprising at least one processor, at least one memory including computer program code, the at least one memory and computer program code configured to, with the at least one processor, cause the network device at least to perform:
obtaining information descriptive of a capability of a network entity of another network 30 device, said network entity comprising a capability for providing an output based on an artificial intelligence and/or machine learning inference function related to one or more network objects or object types;
sending, to the other network device, a request for a partial activation of the capability.

According to one or more embodiments, the at least one memory and the computer program are further configured, with the at least one processor, to cause the network device to perform obtaining information descriptive of a plurality of predefined ordered activation levels identifying gradually increasing capability activation scopes; and wherein the request describes the partial activation scope by reference to one of said predefined activation levels.

According to one or more embodiments, the at least one memory and the computer program are further configured, with the at least one processor, to cause the network device to perform receiving, from the other network device, information descriptive of a status of the activation scope of the capability in response to the request.

According to one or more embodiments, the information descriptive of the capability comprises one or more among the following items:
e. one or more objects and/or object types for which the network entity is configured to undertake optimization or control;
f. one or more parameters of the one or more objects and/or object types which the network entity is configured to control or optimize to achieve desired results;
g. one or more network metrics which the network entity is configured to seek improvement of;
h. one or more network characteristics related to the one or more objects and/or object types.

According to one or more embodiments, the request comprises one or more subsets of at least one of the items a to d for describing the partial scope of activation.

According to one or more embodiments, the request comprises at least one among a network context and an artificial intelligence and/or machine learning context for describing the partial activation scope.

According to one or more embodiments, the at least one memory and the computer program are further configured, with the at least one processor, to cause the network device to perform determining if data descriptive of a performance of the capability further to the activation of the capability at the requested activation scope meets a performance criterion, and in the affirmative, sending (208) a request for an increase of the previously requested activation scope to the other network device.

According to one or more embodiments, the at least one memory and the computer program are further configured, with the at least one processor, to cause the network device to perform requesting an increase of the scope of activation of the capability only a full scope of activation has not yet been reached.

According to one or more embodiments, the at least one memory and the computer program are further configured, with the at least one processor, to cause the network device to perform:
if the criterion is not met, sending a request for deactivation to the other network device identifying one of:
   an instruction to undo the activation scope request;
   a complete deactivation of the capability;
   a reduced scope of activation to be achieved compared to the scope of activation for which the criterion was not met;
   one or more parts of the activation scope of the capability that are to be deactivated;
   a level among the plurality of predefined ordered activation levels identifying gradually increasing capability activation scopes.

According to one or more embodiments, the at least one memory and the computer program are further configured, with the at least one processor, to cause the network device to perform determining network performance degradation and requesting a partial decrease in capability activation scope responsive to said determining.

According to one or more embodiments, the at least one memory and the computer program are further configured, with the at least one processor, to cause the network device to perform obtaining from the other network device at least one of an accuracy measurement or data descriptive of a benefit evaluation carried out by the other device, wherein said accuracy measurement or data descriptive of a benefit evaluation are function of an output of said capability for an envisioned partial activation scope without application of said output to an operational environment and sending said request for partial activation as a function of the at least one of an accuracy measurement or data descriptive of a benefit evaluation.

A fourth aspect concerns a network device comprising at least one processor, at least one memory including computer program code, said network device comprising a network entity comprising a capability for providing an output based on an artificial intelligence and/or machine learning inference function related to one or more network objects or object types, the at least one memory and computer program code configured to, with the at least one processor, cause the network device at least to perform partial activation of the capability.

According to one or more embodiments, the at least one memory and the computer program are further configured, with the at least one processor, to cause the network device to perform making available to other network devices, information descriptive of the capability.

According to one or more embodiments, the at least one memory and the computer program are further configured, with the at least one processor, to cause the network device to perform making available, to other network devices, information descriptive of a plurality of predefined ordered activation levels identifying gradually increasing capability activation scopes within the available scope.

According to one or more embodiments, the at least one memory and the computer program are further configured, with the at least one processor, to cause the network device to perform making available, to other network devices, at least one of an accuracy measurement or data descriptive of a benefit evaluation carried out by the other device, wherein said accuracy measurement or data descriptive of a benefit evaluation is function of an output of said capability for an envisioned change in activation scope without application of said output to an operational environment.

According to one or more embodiments, the information on the available scope of activation comprises one or more among the following items:
e. one or more objects and/or object types for which the network entity is configured to undertake optimization or control;
f. one or more parameters of the one or more objects and/or object types which the network entity is configured to control or optimize to achieve desired results;
g. one or more network metrics which the network entity is configured to seek improvement of;
h. one or more network characteristics related to the one or more objects and/or object types.

According to one or more embodiments partial activation of the capability is performed in response to a request for partial activation from another network device.

According to one or more embodiments the at least one memory and the computer program are further configured, with the at least one processor, to cause the network device to perform,
after activation of the capability at the requested scope, sending, to the other network device, status information descriptive of an activation status of the capability with regard to the requested scope.

According to one or more embodiments, the at least one memory and the computer program are further configured, with the at least one processor, to cause the network device to perform:
receiving, in the request, at least one among a network context and an artificial intelligence and/or machine learning context; and
responsive to the context, limiting the scope of activation of the capability.

According to one or more embodiments, the at least one memory and the computer program are further configured, with the at least one processor, to cause the network device to perform determining network performance degradation and partially decreasing the capability activation scope responsive to said determining.

According to one or more embodiments, the activation of the capability comprises application of an output of the capability to an operational network environment.

A fifth aspect concerns a computer-readable medium comprising program instructions stored thereon for performing at least the following
obtaining information descriptive of a capability of a network entity of a second network device, said network entity comprising a capability for providing an output based on an artificial intelligence and/or machine learning inference function related to one or more network objects or object types;
sending to the second network device a request for a partial activation of the capability.

A sixth aspect concerns a computer-readable medium comprising program instructions stored thereon for performing at least the following in a network device comprising a network entity, the network entity comprising a capability for providing an output based on an artificial intelligence and/or machine learning inference function related to one or more network objects or object types;
partial activation of the capability.

According to one or more embodiments, the computer readable media may be non-transitory.

### BRIEF DESCRIPTION OF THE DRAWINGS

The accompanying drawings, which are incorporated in and constitute a part of this specification, illustrate example embodiments together with the general description given above, and the detailed description given below.

FIG. 1 is a block diagram of a system according to one or more exemplary embodiments.

FIG. 2 is a flowchart of a method carried out at an AI/ML management service consumer according to one or more exemplary embodiments.

FIGS. 3a and 3b are flowcharts of methods carried out at an AI/ML management service producer according to one or more exemplary embodiments.

FIG. 4 is a message sequence chart showing an AI/ML management service consumer and AI/ML management service producer according to one or more exemplary embodiments.

FIG. 5 is an exemplary hardware structure of an apparatus according to one or more exemplary embodiments.

It should be noted that these drawings are intended to illustrate various aspects of devices, methods and structures used in example embodiments described herein. The use of similar or identical reference numbers in the various drawings is intended to indicate the presence of a similar or identical element or feature.

### DETAILED DESCRIPTION

Detailed example embodiments are disclosed herein. However, specific structural and functional details disclosed herein are merely representative for purposes of describing example embodiments. Accordingly, these embodiments are shown by way of illustrative examples in the drawings and will be described herein in detail so as to provide a thorough understanding of the various aspects. However, it will be understood by one of ordinary skill in the art that example embodiments are capable of various modifications and alternative forms and may be practiced without all the specific details. In addition, systems and processes may be shown in block diagrams so as not to obscure the example embodiments in unnecessary detail. In other instances, well-known processes, structures, and techniques may be shown without unnecessary detail in order to avoid obscuring the example embodiments.

Exemplary embodiments provide apparatuses, methods, systems and computer programs for the gradual activation of Artificial Intelligence (AI) and/or Machine Learning (ML) capabilities.

The terms artificial intelligence and machine learning (“AI/ML”) refer to software-implemented methods based on mathematical algorithms or models providing an inference function.

Such models are typically mathematical algorithms, trained with information and that replicate a decision an expert would make when provided that same information. According to some embodiments, AI/ML functions may also provide data analytics. An AI/ML training function associated e.g. with a model takes data, runs the data through the AI/ML model and derives the associated loss and adjust the parameterization of that AI/ML model based on the computed loss. Training methods may include supervised learning, unsupervised learning and reinforcement learning, and training may be performed offline or be continuous. The inference function can be one of a number of known categories, such as regression-based, clustering- or association based, reward-based behavior, with an appropriate training method being applied.

Exemplary applications of AI and/or ML comprise without limitation: voice recognition; image processing/computer vision; natural language processing; information retrieval; personalization and recommendation; robotics, data analytics including predictive and prescriptive analytics; use-cases for the design and/or planning and/or optimization and/or configuration and/or control and/or management of communication systems and/or networks.

Exemplary use-cases may be without limitation:
use-cases related to the physical-layer of communication networks such as modulation, coding, decoding, signal detection, channel estimation, prediction, compression, interference mitigation;
use-cases related to the medium access control layer of communication networks such as multiple access and resource allocation (e.g., power control, scheduling, spectrum management);
channel modeling;
network optimization;
cell capacity estimation in cellular networks;
routing;
resource management;
data traffic management;
security and anomaly detection;
root cause analysis;
transport protocol design and optimization;
user/network/application behavior analysis/prediction;
transport-layer congestion control;
user experience modeling and optimization;
user mobility and positioning management;
network slicing, network virtualization and software defined networking;
non-linear impairments compensation in optical networks (e.g., visible-light communications, fiber-optics communications, and fiber-wireless converged networks), and
quality-of-transmission estimation and optical performance monitoring in optical networks.

The term AI/ML entity designates any network entity that contains one or more AI and/or ML capabilities.

Exemplary network entities comprise without limitation:
radio access network entities such as base stations (e.g., cellular base stations like eNodeB in LTE and LTE-advanced networks and gNodeB used in 5G networks, and femtocells used at homes or at business centers);
relay stations;
control stations (e.g., radio network controllers, base station controllers, network switching sub-systems);
access points in local area networks or ad-hoc networks;
gateways and radio access network entities;
network management entities (e.g., Operation, Administration and Management (OAM) entity);
network automation systems;
distributed analytics entities such as self-autonomous systems (D-SONs);
network functions (e.g., network data analytics function, NWDAF, defined in current 3GPP standards);
user equipment (UE).

An AI/ML Management Service (‘MnS’) producer, e.g. a network or management function within a network entity, applies AI/ML to accomplish specific tasks. The AI/ML Management Service (‘MnS’) is considered to comprise one or more AI/ML entities, each having specific AI/ML capabilities.

According to one or more embodiments, a Management Service is a set of offered capabilities for management and orchestration of network and services. The entity producing an MnS is called MnS producer. The entity consuming an MnS is called MnS consumer. An MnS provided by an MnS producer can be consumed by any entity with appropriate authorisation and authentication.

An AI/ML entity provides capabilities to an AI/ML MnS consumer through an AI/ML MnS producer. Exemplary outputs of an AI/ML entity capability comprise decisions or data analytics. Exemplary analytics and/or decision functions comprise without limitation: coverage analysis, coverage problems analysis, handover problems analysis, faults detection, interference detection, coverage optimization, capacity optimization, handover optimization, interference reduction, energy saving optimization. The AI/ML MnS producer is a function that may be implemented through software and/or hardware by any appropriate network entity (e.g. a network management function, an automation function, an analytics function, or a network function like a gNB, or cell) configured to provide an interface for AI/ML capability exposure on behalf of one or more AI/ML entities. The AI/ML MnS consumer is a function that may be implemented by any network entity. According to one or more embodiments, the MnS consumer is required to have appropriate authorization and authentication.

According to one or more embodiments, an AI/ML MnS producer is implemented by software run by a network entity (or possibly several entities) and AI/ML entities are part of this software.

According to one or more embodiments, the decision making capability of an AI/ML entity is described as a triplet <object(s), parameters, metrics> with the entries respectively indicating: the object or object types for which the AI/ML entity can undertake optimization or control, the configuration parameters of the stated object or object types, which the AI/ML entity optimizes or controls to achieve the desired outcomes and the network metrics which the AI/ML entity optimizes through its actions.

Decisions may take the form of recommendations or predictions. For example, a decision output by an AI/ML entity may be a recommendation based on an AI/ML model as to whether the handover of a UE to a new cell is to be carried out, or a prediction of the next target cell of a UE. The AI/ML MnS producer acts on the network based on the output of the AI/ML entity.

When the output of an AI/ML entity is a decision, the AI/ML MnS producer implements this decision. For example, if the output of the AI/ML entity is an antenna tilt, the AI/ML MnS producer will adjust the antenna accordingly, or if the output is a decision to handover to a new cell, the AI/ML MnS producer initiates the handover. When the output of the AI/ML entity is composed of data analytics, AI/ML MnS producer also takes actions affecting the network. E.g. if provided analytics data concern Network Function (NF) load, the scaling of that NF can be performed, e.g. either downscaling it if the NF is underloaded or upscaling it if it is overloaded, based on provided analytics.

According to one or more embodiments, the data analytics capability of an AI/ML entity is described as a tuple <object(s), characteristics> with the entries respectively indicating: the object or object types for which the AI/ML entity can undertake analytics and the network characteristics (related to the stated object or object types) for which the AI/ML entity produces analytics. As a non-limiting example, the load of a single network function and/or object, or of a set of network functions and/or objects, or of object type, is one characteristic for which the analytics can be produced. For example, an AI/ML capability for the load for the object type ‘cell’ would provide analytics for the load experienced by any cell in the network.

An AI/ML entity may receive input data from a host apparatus or from another network entity (e.g. from or network devices like sensors, data producers, etc). An AI/ML entity may generate output data that may be used by the host apparatus or by another network entity. The host apparatus may be located within the communication network such that the AI/ML entity has access to the required input data and may output data for concerned network entities.

In one or more embodiments, the proposed system provides an AI/ML capability discovery process implemented between the AI/ML MnS consumer and the AI/ML MnS producer for one or more AI/ML entities hosted by the AI/ML MnS producer. For that purpose, the AI/ML MnS producer exposes capability information. The capability information may be received by an AI/ML MnS consumer in response to a request sent from the AI/ML MnS consumer to one or more AI/ML MnS producers. The capability information may also be received on the basis of a subscription scheme in which the AI/ML MnS consumer sends at least one request to receive capability information to one or more AI/ML MnS producers and receives the capability information matching the request when new AI/ML entities are available within these producers.

The capability information may be exposed over an interface (e.g. an open interface) between the AI/ML MnS consumer and the AI/ML MnS producer. This interface may be used for various operations including at least one of:
sending a request for capability information from the AI/ML MnS consumer to the AI/ML MnS producer;
receiving capability information by the AI/ML MnS consumer from the AI/ML MnS producer;
sending configuration data of an AI/ML entity from the AI/ML MnS consumer to the AI/ML MnS producer for an entity hosted by the latter.

The capability information exposed for the available AI/ML functionalities may include various types of information, as described below.

The capability information may include a description of the functionality or AI/ML model implemented by the concerned AI/ML entity. The description may include at least one of a text (e.g. “predicting the QoS level within a QoS scope”), keywords, an identification a functionality within a list of predefined functionalities, etc.

The capability information of an AI/ML entity may include information representative of a type of function performed by the AI/ML entity for the communication network. The type may be at least one of: an optimization function, a control function, an analytics function and an AI/ML orchestration function. Other relevant types may be used. The type of function may be identified by a name or an identifier within a list of identifiers or using another type of identification method.

The capability information of an AI/ML entity may include information representative of entities for which the functionality implemented by the AI/ML entity is applied. These entities may be one or more objects or one or more object types (e.g. “UEs”, “cells” . . . ). An object may be used as input or output of the AI/ML entity. E.g; the AI/ML entity may provide as output a target cell to which a handover is to be performed, in this case the object ‘cell’ is part of the output generated by the AI/ML entity. An object may correspond to any entity in the communication network: a UE, a network entity, a functional unit, a virtual function, a database, or other similar/related objects. The object or object type may be identified by a name or an identifier or using another type of identification method.

The capability information may include information representative of at least one configuration parameter for an object or object type for which the AI/ML capability or function provided by the AI/ML entity is performed. The configuration parameter for an object or object type may be any parameter that is usable to configure the concerned object. For example, a cell needs to have an antenna tilt to determine where the antenna should face to maximize coverage and minimize interference. The antenna tilt in this example is a configuration parameter for the object cell. A configuration parameter for an object or object type is an example of a configuration parameter of an AI/ML entity.

The capability information may include information representative of a configuration parameter for an AI/ML model implemented by the AI/ML entity. The configuration parameter (meta-parameter, input parameter, etc. . . . ) for an AI/ML model may be any parameter that is usable to configure the concerned model. For example, an AI/ML model may have inputs which the model uses to drive to decisions, e.g. a model to optimize coverage may take the antenna tilt as input data. In this case the antenna tilt is a configuration parameter of the model. A configuration parameter for an object or object type is an example of a configuration parameter of an AI/ML entity.

The capability information may include information representative of an objective and/or constraint for the execution of the capability or function, wherein the objective and/or constraint is defined on the basis of at least one network metric. Such an objective and/or constraint may be coded by a text, may be identified by a name or an identifier within a list of objectives or using another type of identification method.

The capability information of an AI/ML entity may be coded and reported in various formats. The capability information of an AI/ML entity may be coded using a descriptive text and/or tuples and/or tables, etc.

The capability information may represent a decision. For example the capability information may be in the form of a triplet <x,y,z> indicating
x: the object or object types for which the AI/ML entity can undertake optimization or control;
y: the configuration parameters of object or object types x, which the AI/ML entity optimizes or controls to achieve the desired outcomes;
z: the network metrics which the AI/ML entity optimizes through its actions.

The capability information may represent a data analysis. For example the capability information may be in the form of a tuple <x,z> indicating:
x: the object or object types for which the AI/ML entity can undertake analysis;
z: the network characteristics (on object x) for which the AI/ML entity produces an analysis.

According to one or more exemplary embodiments, an AI/ML MnS consumer is configured to request partial activation of capabilities at an AI/ML entity. Partial activation includes activating a capability at an intermediate scope between a full activation scope and full deactivation.

Partial activation can be performed by selecting an initially reduced scope of activation of AI/ML capabilities compared to a full scope. The AI/ML entity then activates the capability for the initial scope. At a later stage, a new scope of activation can be requested that adds and/or removes scope limitations to arrive at a different scope, which may be partially overlapping with the previous scope, entirely exclusive of the previous scope, or including the previous scope and expanding thereon. The fact that partial activation can be requested does not mean that activation at full scope cannot be requested. Indeed, one or more partial scopes of activation can be requested in succession and then full activation scope can be requested. Conversely, a full activation scope can be requested and then a partial scope of activation may be fallen back on at a later stage.

According to one or more embodiments, partial activation can also be performed by an AI/ML MnS producer instead of, or in addition to, the AI/ML MnS consumer. An AI/ML MnS producer may for example trigger partial activation based on one or more network performance criteria.

According to one or more embodiments, after activation of a capability at an initially reduced scope, the activation scope is gradually expanded. For example, a check is carried out to determine whether one or more performance criteria are met for an initial partial scope. If the one or more criteria are met, an expanded scope compared to the initial partial scope is defined, the AI/ML entity activates the capability at the new scope and the check of performance criteria is carried out again. The process iterates until the performance criteria are not met for a given scope of activation—in that case, that scope is deactivated and the previous scope is fallen back on. At the end of the process, either full activation or partial activation or no activation at all of AI/ML capability will have taken place, according to the scope that last met the performance criteria.

It is difficult to predict and quantify the benefits of using an AI/ML capability in a given operational network context without implementing its results. Partial activation allows an AI/ML MnS consumer to test this partial capability activation scope before rolling out an increased or full activation scope.

Moreover, a full activation scope may not bring the desired performance and even provide a decreased performance. Partial activation of the scope may on the other hand provide benefits that a full activation would not necessarily provide, although the general belief may be that an AI/ML capability unconditionally improves network performance. In addition, the partial activation scope can be modified in various ways, including being gradually increased, e.g. until a desired performance level or the highest possible performance level is reached. In other words, a finer control of AI/ML capability activation is achieved.

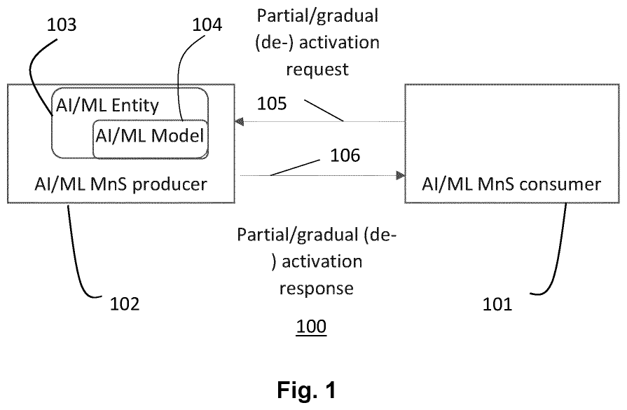

FIG. 1 is a block diagram of a system 100 according to one or more exemplary embodiments. The system comprises an AI/ML MnS consumer 101 and an AI/ML MnS producer 102. The latter comprises an AI/ML entity 103, which itself comprises an AI/ML function, implemented e.g. using an AI/ML model. 104. The AI/ML MnS consumer can request partial—and in particular gradual—activation or deactivation of one or more AI/ML capabilities of the AI/ML entity by sending an appropriate request 105 to the AI/ML MnS producer. A response 106 to the request 105 is sent by the producer to the consumer for confirming the status.

An exemplary request for partial activation comprises:
1. An identification of an AI/ML entity to which the request applies
2. An identification of one or more AI/ML capabilities of the AI/ML entity.
3. Information identifying a given scope of activation of an AI/ML capability.
   The information identifying the scope of activation may be described in various ways: an exhaustive list of individual items defining the capability, higher level characteristics (e.g. types), one or more identifiers of predefined sets of items, group and/or type identifiers.

A detailed exemplary request for activation such as request 105 in FIG. 1 is as follows:
1. An identification of an AI/ML entity to which the request applies
2. Information identifying at least one AI/ML capability of the AI/ML entity that is to be activated. According to one or more embodiments, this may include for each AI/ML capability one or more of the following:
   a. A list of one or more network objects and/or one or more network object types for which the AI/ML entity can undertake optimization or control.
      E.g. a network object may be a specific cell, a type of object may be ‘cell’.
   b. A list of one or more parameters of the above objects and/or object types which the AI/ML entity controls or optimizes to achieve desired results.
      Example parameters may include antenna tilt, transmission power.
   c. A list of one or more network metrics which the AI/ML entity seeks to improve through its actions.
      Example metrics include throughput metrics.
   d. A list of one or more network characteristics related to the one or more objects and/or object types for which the AI/ML entity produces analytics.
3. Information defining a scope of activation of the AI/ML capability. According to one or more embodiments, this may include zero, one or more of the following:

### Context

a. Information on the network context
   The network context is data descriptive of a network status at the time of activating an AI/ML capability. For example, the network context specifies the network technology, the geographical or temporal context.
   For example, the context of a first scope may be ‘all gNBs and potential additional RATs are operating’ whereas the context of a second scope may be ‘certain gNBs or other RATs are experiencing a fault or are powered off to save energy’.
b. Information on the AI/ML context for which the AI/ML capability is to be activated. An activation context is defined. It is a subset of an expected runtime context (for the activation of initial AI/ML capabilities in iterations) or a subset of a runtime context for subsequent gradual activation of additional AI/ML capabilities in iterations. The expected runtime context is the context (i.e. the specific conditions) in which the AI/ML model is expected to be applied, whereas the runtime context is the context in which the model is being applied. An AI/ML context can be defined by the statistical properties of the data the AI/ML Entity is using during training or inference.

### Subscope

Information defining a sub-scope of the items in section 2 above, for example one or more of the following:
   an object sub-scope—identification of a subset of the objects (from 2.a.) with respect to which the AI/ML capability should be activated;
   a control parameter sub-scope-identifying a subset of the parameters (from 2.b.) with respect to which an AI/ML capability should be activated;
   metric sub-scope—identifying a subset of the parameters (from 2.c.) with respect to which an AI/ML capability should be activated.

The above is an exemplary request to be adapted to a specific context. E.g. section 2 may contain only information related to a decision triplet or a data analytics tuple. For example for a decision type output, a request would not contain item 2.d.

Other request formats and contents may be used. For example, requests may comprise additional activation scope definition information than specified in the exemplary request. Such additional scope definition information may comprise one or more among timing (start time, duration . . . ), geographical location information of the network objects or types for which the capability is to be activated, information describing a network slice, a UE category, a PDU session, etc. . . . Such information can then be used e.g. to further narrow the activation scope.

According to one or more embodiments, the request may indicate a full scope activation, either explicitly or implicitly. E.g. by default, in case of absence of any context or sub-scope, the full scope is activated.

According to one or more embodiments, a plurality of ordered activation levels or steps are defined. Activation levels predefine one or more AI/ML capabilities and associated, gradually increasing, activation scopes ordered from the smallest scope to the broadest scope. The activation levels are exposed by the AI/ML MnS producer in the same way as AI/ML capability information. An AI/ML MnS consumer activates an activation level through a request that refers to the activation level, without having to spell out any further details such as the sub-scopes. Such levels can also be referred to as ‘abstracted’ activation levels. When activation levels comprise a set of AI/ML capabilities, these may have been grouped according to common characteristics such as for example complexity. For example, an AI/ML MnS producer may define three abstracted activation levels, ‘low’, ‘medium’ and ‘high/full’ with a description of their corresponding characteristics and expose such information. This information may include the AI/ML capability information and the scope related to the activation level, e.g. which AI/ML capabilities shall be activated under which network and/or AI/ML context, if the given activation level is requested by the AI/ML MnS consumer. The low activation level/step may comprise only a single AI/ML capability of low complexity to be activated on a single object, e.g. single cell. Medium activation level may include several AI/ML capabilities to be activated on a limited set of cells, whereas high/full activation may imply complete activation of all AI/ML capabilities of an AI/ML entity over the entire available scope.

According to one or more embodiments, an activation level is defined for an activation of the capability at the full available scope. Using this activation level in a request for activation allows the AI/ML MnS consumer to request full activation, over the entire available scope.

As a response to an activation request, the AI/ML MnS producer provides an activation status to the AI/ML MnS consumer. According to one or more embodiments, this status specifies the AI/ML entities concerned and for each of these in which scope the activation has been successfully performed.

A deactivation request may contain parameters generally similar to those of the activation request. According to one or more embodiments, a deactivation request identifies which part of the activation scope of the capability is to be deactivated. E.g. if the current activation scope of a capability covers cells with the identifiers “Cell ID1, Cell ID2, Cell ID3” and the deactivation request contains ‘Cell ID3’ in the information defining the deactivation scope, then the AI/ML MnS producer will reduce the scope to “Cell ID1, Cell ID2”. According to embodiments, the deactivation request identifies a scope of activation to be achieved and which is reduced compared to the current scope of activation. According to one or more embodiments, a deactivation request may also contain an ‘undo’ of a previously sent activation request. More ways of coding a deactivation scope in a deactivation request may be defined.

According to one or more embodiments, an AI/ML MnS producer provides AI/ML capability evaluation information to the AI/ML MnS consumer, e.g. information on the characteristics of AI/ML capabilities in an operational environment. Such evaluation information can be made available to the AI/ML MnS consumer in the same manner as capability information. An evaluation of an AI/ML capability is carried out by the AI/ML entity by executing the AI/ML capability without taking an action based on the resulting solution (i.e. without implementing the decision output), and measuring the accuracy of the AI/ML solution in the operational environment compared to non-AI/ML solutions or, in certain cases, determining the benefits and the impact of the AI/ML capability. An AI/ML MnS consumer can obtain the measured accuracy, or the benefits, of the AI/ML from the AI/ML entity. Based on this information, the AI/ML MnS consumer may decide whether or not to request activation of the AI/ML capability.

In more detail, the exposure of such evaluation information may be (a) requested by the AI/ML MnS consumer and/or (b) initiated by the AI/ML MnS producer. The AI/ML MnS producer may run the AI/ML capability or capabilities by feeding operational data as input data to the AI/ML entity, but without applying the AI/ML capability outputs to the operational network, e.g. without implementing the decisions based on AI/ML capability predictions. Such information on AI/ML operational characteristics may take the form of an accuracy indicator of an AI/ML solution when applied to operational data. In some use cases, the evaluation information can be expressed in terms of benefits/impacts of applying the AI/ML capability output in an operational environment. For example, an AI/ML entity's capability may be to predict the Virtual Network Function (VNF) load and provide a recommendation to scale it up or down. At 1 pm, an operator checks the output of this capability, which predicts the VNF load for example for one hour later., e.g. at 2 pm, but will not perform the recommended scaling. At 2 pm, the operator determines the actual VNF load and compares it to what AI/ML entity predicted. Based on this comparison, accuracy of the prediction can be calculated. However, an evaluation is applicable only to certain metrics, e.g. virtual resource costs/amount in this case. For other metrics, such as for example the corresponding Quality of Experience, QoE, of the users affected by the changes required for following recommendation/decision provided the AI/ML capability output, applying the recommended changes in the network environment, e.g. scaling down of certain NFs, may be necessary to evaluate performance.

As indicated in FIG. 1 and the related section of the above description, deactivation of an AI/ML capability can be requested by an AI/ML MnS consumer. In response to a deactivation request, the AI/ML MnS producer deactivates the AI/ML capability (or capabilities) as specified and provides status information to the AI/ML MnS consumer in return.

Deactivation may be complete, or deactivation may be partial, e.g. by identifying specific items to be excluded from the currently applied activation scope, or as an undo of AI/ML capabilities activated through a previous activation request. The abstracted activation levels described above may also be used in a request to deactivate AI/ML capabilities.

As a response to a deactivation request, the AI/ML producer provides a deactivation status to the AI/ML consumer. According to one or more embodiments, this status specifies the AI/ML entities concerned and for each of these in which scope the deactivation has been successfully performed.

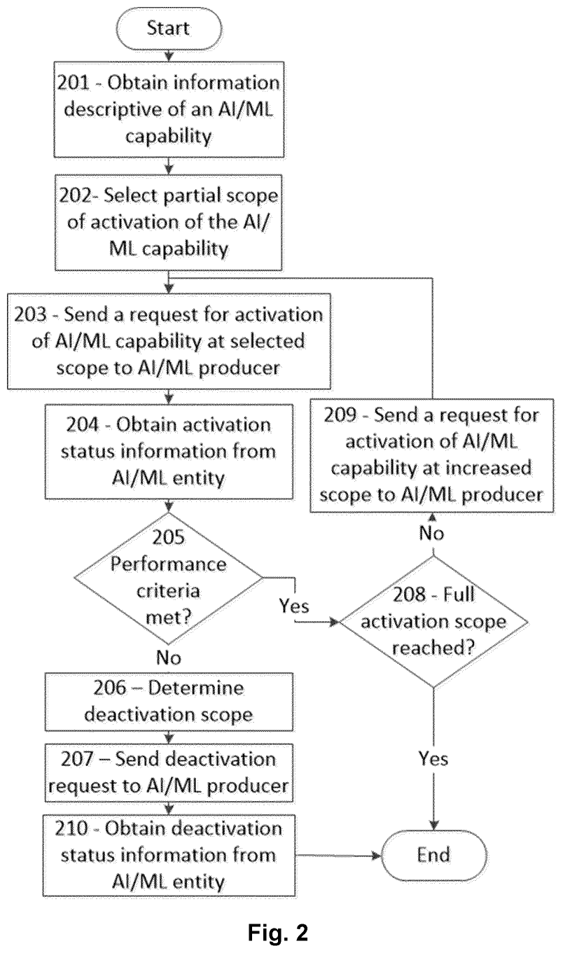

FIG. 2 is a flowchart of a method according to one or more embodiments carried out at an AI/ML MnS consumer. At 201, the AI MnS consumer first obtains AI/ML capability information descriptive of the capability of the AI/ML entity. Note that this step is optional if the AI/ML MnS consumer already disposes of this information, e.g. it obtained such information previously. The AI/ML MnS consumer then selects (202) a partial scope of activation of the AI/ML capability and sends (203) a request for activation characterizing this partial scope to the AI/ML MnS producer which houses the AI/ML entity.

According to one or more embodiments, a scope of activation to be achieved may, for example and without limitation, be defined in the request, based on at least one of a subset of the information descriptive of the capability obtained earlier, and/or a network context, and/or an AI/ML context. The network and the AI/ML context would typically be provided by the AI/ML MnS consumer in the request for activation (203).

Optionally, the request identifies one of a plurality of abstract activation levels defining gradual capability activation steps as described earlier. Once the AI/ML entity has activated the capability at the requested level, the AI/ML MnS consumer receives (204) a status report from the AI/ML MnS producer regarding with which scope the capability has effectively been activated. The AI/ML MnS consumer then obtains information descriptive of the performance at the selected scope following the activation (e.g. network performance obtained through measurements) and makes a determination as to whether this performance is satisfactory or not based on one or more criteria (205). If this is the case (and unless a full scope of activation has been reached (208)), the AI/ML MnS consumer increases the scope of activation (209) and sends a further request (iteration at 203), followed by a further performance check (205). The method thus gradually and iteratively increases the scope of activation. If the performance is not satisfactory, the AI/ML MnS consumer instead determines a scope of deactivation (206), issues a request for deactivation (207). The request for deactivation identifies a reduced activation scope compared to the scope that led to the unsatisfactory performance. The reduced activation scope can for example be identified in the same way as in an activation request. The AI/ML MnS consumer then receives (210) a status report regarding the deactivation request from the AI/ML producer.

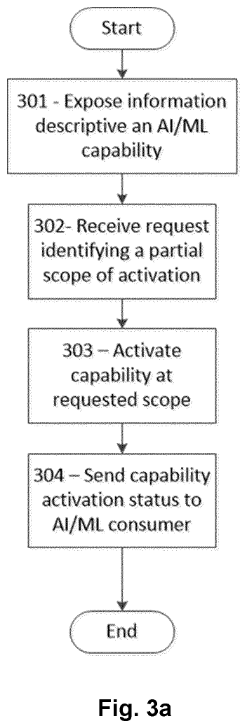

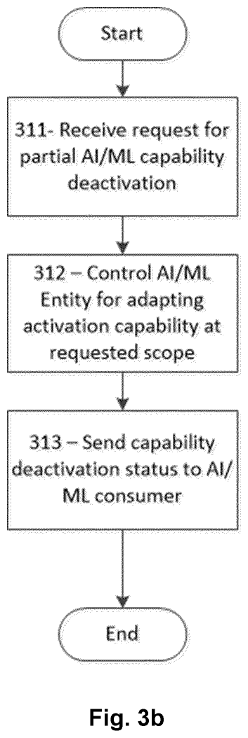

FIG. 3a is a flowchart of a first method according to one or more embodiments carried out at an AI/ML MnS producer. At 301, the AI/ML MnS producer provides an interface exposing information descriptive of a capability of an AI/ML entity for one or more AI/ML MnS consumers to obtain information with regard to the scope at which the capability can be activated. According to one or more embodiments, other information may be used, in place of, or in addition to, the information exposed by the AI/ML MnS producer to define a partial scope of activation. For example, a context such as a network context or AI/ML context may be used.

Optionally, this information comprises several abstract activation levels defining gradual capability activation steps as described earlier. The AI/ML MnS producer receives at 302 a request from the AI/ML MnS consumer identifying a partial scope of activation for a given capability. The AI/ML MnS producer activates the AI/ML capability of the AI/ML entity at the requested partial scope at 303. At, 304, the AI/ML MnS producer then sends a status report to the AI/ML MnS consumer that issued the request. The report provides information on the scope at which the AI/ML capability has effectively been activated.

FIG. 3b is a flowchart of a second method according to one or more embodiments carried out at an AI/ML MnS producer. At 311, the AI/ML MnS producer receives a request from the AI/ML MnS consumer identifying a partial scope of deactivation for a given capability. The AI/ML MnS producer deactivates the AI/ML capability of the AI/ML entity as requested at 311. At 312, the AI/ML MnS producer sends a status report to the AI/ML MnS consumer that issued the request. The report provides information on the scope at which the AI/ML capability has effectively been deactivated, e.g. ‘predefined abstraction level 3 has been successfully deactivated’.

According to a first exemplary use case, the AI/ML MnS producer is a User Equipment (UE) running an AI/ML model for predicting the UE location/trajectory. The AI/ML MnS consumer is a base station, gNB, which uses the predicted UE information to trigger a handover. The AI/ML MnS consumer, i.e. the gNB, gradually activates/de-activates the AI/ML capability at a single UE, or at a plurality of selected UEs.

According to a second exemplary use case, the AI/ML MnS producer is a Capacity and Coverage Optimization (CCO) Self-Organizing Networks (SON) function which runs an AI/ML model to adjust the control parameters in order to achieve efficient network resource usage and optimal end-user experience. The AI/ML MnS consumer is an Operator/Network Management system (OAM) of an operator which aims at improving the network performance and the UE Quality of Service (QOS). The AI/ML MnS consumer gradually activates/de-activates the CCO capabilities in a cell or at selected cells among all available cells and possibly for a selected context at first. The scope is expanded later.

In the above example, the CCO (Capacity and Coverage Optimization) SON (Self-Organizing Networks) function AI/ML capabilities are exposed by specifying the following tuple:
(a) Control parameters
   The control parameters may comprise any one or more control parameters of a CCO (e.g. configured maximum transmission power, configured maximum EIRP, coverage shape, digital tilt, digital azimuth).
(b) Metrics
   The metrics may include any one or more CCO-related performance measurements (e.g. Distribution of SS-RSRP per SSB, Distribution of SS-RSRQ, Distribution of the number of active UE per SSB, Number of requested handover executions, Number of failed handover executions, Distribution of DL Total PRB Usage, Distribution of UL Total PRB Usage, DL PRB used for data traffic, DL total available PRB, UL PRB used for data traffic, UL total available PRB, Average DL UE throughput in gNB, Distribution of DL UE throughput in gNB, Average UL UE throughput in gNB, Distribution of UL UE throughput in gNB, Mean number of RRC Connections, Max number of RRC Connections, Number of PDU Sessions requested to setup, Number of PDU Sessions successfully setup, Number of PDU Sessions failed to setup)
(c) Object type: Cell

The same tuple is used in an activation request. The AI/ML MnS consumer, i.e. the Operator/Network Management system (OAM) of an operator initially specifies in the request the context information (e.g. the geographical/time/technology context) and additional sub-scope information such as a sub-scope limited to a single control parameter such as antenna tilt (digital tilt) and a subset of cells for which the AI/ML capabilities are to be activated. Once a satisfying performance is achieved, the sub-scope is extended to include further control parameters, in this case for example transmission power, and also a broader geographical/temporal/technology context.

An exemplary request within the frame of the second use case is as follows:
AIMLEntityID=“CCO_ID1”
AI/ML capabilities:
   Objects: Cell ID1, Cell ID2, Cell ID3, Cell ID4, Cell ID5, Cell ID6, Object type: Cell
   Control parameters: antenna tilt, transmission power
Scope to be activated:
   Network context: 5G RAT, FR1
   AI/ML context: geographical areas of Munich suburb_north and suburb_south, nighttime, low traffic
   Object sub scope: Cell ID1, Cell ID2, Cell ID3
   Parameter sub scope: antenna tilt

An exemplary status report sent by the AI/ML MnS producer after activation of the scope in this request is as follows:
AIMLEntityID=“CCO_ID1”
Activation time: e.g. 22:00 CET
Status: Activated
Activated capabilities: Cell ID1, Cell ID2, Cell ID3, antenna tilt
Scope: 5G RAT FR1, suburb_north and suburb_south, 5% of maximum traffic in the selected areas

After this step, the AI/ML MnS producer and/or consumer monitor the network performance and decide if further expansion of the capabilities and/or scope is required. For example, supposing that performance is satisfactory for the initial partial scope of cells with the IDs 1,2,3, this scope can gradually be increased. A first expansion of the scope may be made by adding the cells with the IDs 4, 5, 6 and requested in a second request. The transmission power as a control parameter can be added at the same time or in a third request of the activation scope. Other areas such as suburb_east and suburb_west, and/or other times of the day, such as the afternoon hours may be added to the activation scope, as can be the second frequency range FR2.

In the case that AI/ML MnS consumer requested partial or gradual activation using an abstracted activation level/step, e.g. ‘low’. The AI/ML MnS producer may provide the status and the description of activated capabilities in a subsequent step. Based on monitored network performance, the AI/ML MnS consumer may decide to increase the activation scope by specifying the next level/step in the activation request, e.g., “medium”, and then later on “high/full”.

When monitoring network performance, the AI/ML MnS consumer, or the producer, may identify a degradation of this network performance. Based on such an event, the AI/ML MnS consumer may request deactivation of AI/ML capabilities, either by requesting the deactivation of all capabilities of an entire AI/ML entity, or of selected AI/ML capabilities, assuming this entity offers several capabilities. Selective deactivation of capabilities can be useful if during the gradual activation, the network performance degrades after certain capabilities have been activated with a certain scope. The AI/ML MnS consumer (or producer) may request gradual deactivation (roll-back) of critical AI/ML capabilities.

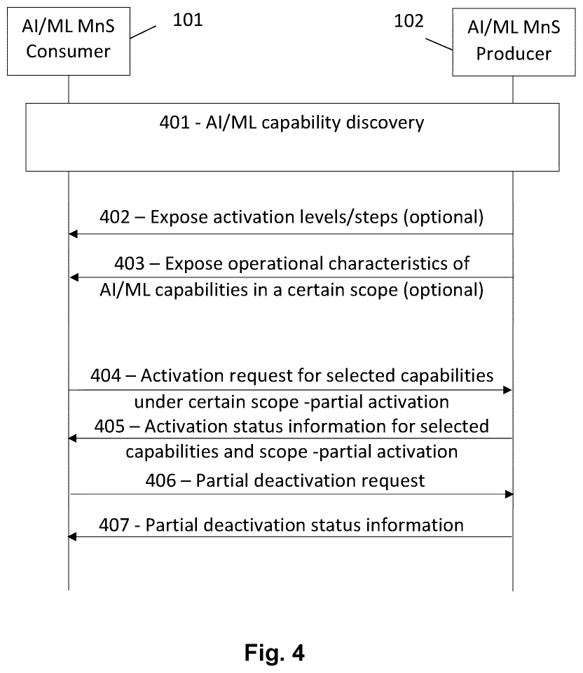

FIG. 4 is a message sequence chart showing an AI/ML MnS consumer and an AI/ML MnS producer according to one or more exemplary embodiments and illustrating the different requests and responses exchanged between the two functions. At 401, capability discovery is performed between the AI/ML MnS consumer and the AI/ML MnS producer. At 402, the abstracted activation levels are optionally exposed by the AI/ML MnS producer for obtention by the AI/ML MnS consumer. At 403, operational characteristics of the AI/ML capabilities of the AI/ML entity or entities of the AI/ML MnS producer are optionally exposed for obtention by the AI/ML MnS consumer. These operational characteristics may comprise the accuracy measurements and/or the benefits and impacts of AI/ML solutions as described earlier. At 404, the AI/ML MnS consumer sends a request for partial activation to the AI/ML MnS producer. At 405, the AI/ML MnS producer provides a status report of the partial activation for the one or more capabilities identified in the request. At 406, the AI/ML MnS consumer sends a request for partial deactivation to the AI/ML MnS producer. At 407, the AI/ML MnS producer sends a status report of the deactivation for the one or more capabilities identified in the request.

With regard to deactivation, FIG. 4 illustrates the case in which deactivation is initiated by the AI/ML MnS consumer (at 406). The partial deactivation request may contain parameters similar to those of the activation request. Complete deactivation of an AI/ML entity can for example be requested by providing only the AI/ML entity's identifier in the request.

Similar to activation, deactivation may also be performed based on abstracted activation levels/steps exposed by the AI/ML MnS producer. The deactivation request issued by AI/ML MnS consumer then includes the level/step which needs to be deactivated by the AI/ML MnS producer. In response, the activation scope is set back to the immediately preceding level of more reduced scope.

It should be appreciated by those skilled in the art that any functions, engines, block diagrams, flow diagrams, state transition diagrams, flowchart and/or data structures described herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processing apparatus, whether or not such computer or processor is explicitly shown.

Although a flow chart may describe operations as a sequential process, many of the operations may be performed in parallel, concurrently or simultaneously. Also some operations may be omitted, combined or performed in different order. A process may be terminated when its operations are completed but may also have additional steps not disclosed in the figure or description. A process may correspond to a method, function, procedure, subroutine, subprogram, etc. When a process corresponds to a function, its termination may correspond to a return of the function to the calling function or the main function.

Each described function, engine, block, step described herein can be implemented in hardware, software, firmware, middleware, microcode, or any suitable combination thereof.

When implemented in software, firmware, middleware or microcode, instructions to perform the necessary tasks may be stored in a computer readable medium that may be or not included in a host apparatus or system. The instructions may be transmitted over the computer-readable medium and be loaded onto the host apparatus or system. The instructions are configured to cause the host apparatus/system to perform one or more functions disclosed herein. For example, as mentioned above, according to one or more examples, at least one memory may include or store instructions, the at least one memory and the instructions may be configured to, with at least one processor, cause the host apparatus/system to perform the one or more functions. Additionally, the processor, memory and instructions, serve as means for providing or causing performance by the host apparatus/system of one or more functions disclosed herein.

The host apparatus or system may be a general-purpose computer and/or computing system, a special purpose computer and/or computing system, a programmable processing apparatus and/or system, a machine, etc. The host apparatus or system may be or include or be part of: a user equipment, client device, mobile phone, laptop, computer, network element, data server, network resource controller, network apparatus, router, gateway, network node, computer, cloud-based server, web server, application server, proxy server, etc.

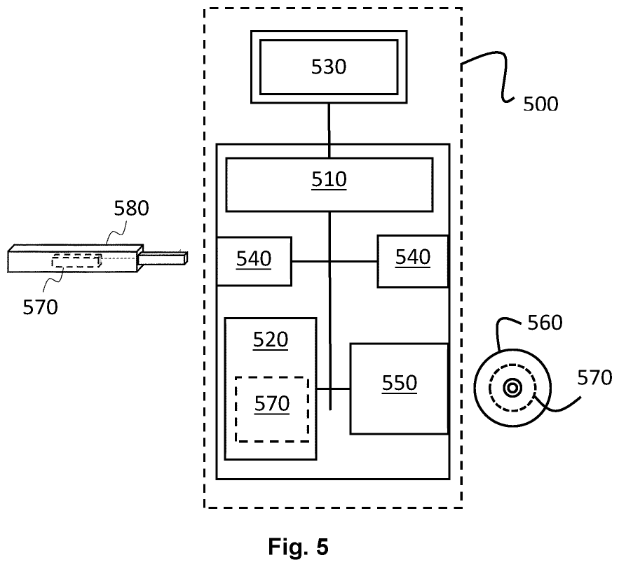

FIG. 5 illustrates an example embodiment of an apparatus 500. The apparatus 500 may be an AI/ML consumer or an AI/ML producer as disclosed herein. The apparatus may be configured to host at least one AI/ML entity disclosed herein.

As represented schematically by FIG. 5, the apparatus 500 may include at least one processor 510 and at least one memory 520. The apparatus 500 may include one or more communication interfaces 540 (e.g. network interfaces for access to a wired/wireless network, including Ethernet interface, WIFI interface, USB interfaces etc) connected to the processor and configured to communicate via wired/non wired communication link(s). The apparatus 500 may include other associated hardware such as user interfaces 530 (e.g. keyboard, mouse, display screen, etc. . . . ) in communication with the processor. The apparatus 500 may further include one or more media drives 550 for reading a computer-readable storage medium (e.g. digital storage disc 560 (CD-ROM, DVD, Blue Ray, etc), USB key 580, etc). The processor 510 is operatively connected to each of the other components 530, 540, 550 in order to control operation thereof.

The memory 520 may include a random access memory (RAM), cache memory, non-volatile memory, backup memory (e.g., programmable or flash memories), read-only memory (ROM), a hard disk drive (HDD), a solid state drive (SSD) or any combination thereof. The ROM of the memory 520 may be configured to store, amongst other things, an operating system of the apparatus 500 and/or one or more computer program code of one or more software applications. The RAM of the memory 520 may be used by the processor 510 for the temporary storage of data.

The processor 510 may be configured to store, read, load, execute and/or otherwise process instructions 570 stored in a computer-readable storage medium 560, 580 and/or in the memory 520 such that, when the instructions are executed by the processor, the apparatus 500 is caused to perform one or more or all steps of a method described herein for the concerned apparatus 500.

The instructions may correspond to computer program instructions, computer program code and may include one or more code segments. A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

When provided by a processor, the functions may be provided by a single dedicated processor, by a single shared processor, or by a plurality of individual processors, some of which may be shared. The term “processor” should not be construed to refer exclusively to hardware capable of executing software and may implicitly include one or more processing circuits, whether programmable or not. A processor or likewise a processing circuit may correspond to a digital signal processor (DSP), a network processor, an application specific integrated circuit (ASIC), a field programmable gate array (FPGA), a System-on-Chips (SoC), a Central Processing Unit (CPU), a Processing Unit (CPU), an arithmetic logic unit (ALU), a programmable logic unit (PLU), a processing core, a programmable logic, a microprocessor, a controller, a microcontroller, a microcomputer, any device capable of responding to and/or executing instructions in a defined manner and/or according to a defined logic.

Other hardware, conventional or custom, may also be included. A processor or processing circuit may be configured to execute instructions adapted for causing the host apparatus or system to perform one or more functions disclosed herein for the concerned host apparatus or system.

A computer readable medium or computer readable storage medium may be any tangible storage medium suitable for storing instructions readable by a computer or a processor. A computer readable medium may be more generally any storage medium capable of storing and/or containing and/or carrying instructions and/or data. A computer-readable medium may be a portable or fixed storage medium. A computer readable medium may include one or more storage device like a permanent mass storage device, magnetic storage medium, optical storage medium, digital storage disc (CD-ROM, DVD, Blue Ray, etc), USB key or dongle or peripheral, a memory suitable for storing instructions readable by a computer or a processor.

A memory suitable for storing instructions readable by a computer or a processor may be for example: read only memory (ROM), a permanent mass storage device such as a disk drive, a hard disk drive (HDD), a solid state drive (SSD), a memory card, a core memory, a flash memory, or any combination thereof.

In the present description, the wording “means configured to perform one or more functions” or “means for performing one or more functions” may correspond to one or more functional blocks comprising circuitry that is adapted for performing or configured to perform the concerned function(s). The block may perform itself this function or may cooperate and/or communicate with other one or more blocks to perform this function. The “means” may correspond to or be implemented as “one or more modules”, “one or more devices”, “one or more units”, etc. The means may include at least one processor and at least one memory including computer program code, wherein the at least one memory and the computer program code are configured to, with the at least one processor, cause an apparatus or system to perform the concerned function(s).

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit for a network element or network node or any other computing device or network device.

The term circuitry may cover digital signal processor (DSP) hardware, network processor, application specific integrated circuit (ASIC), field programmable gate array (FPGA), etc. The circuitry may be or include, for example, hardware, programmable logic, a programmable processor that executes software or firmware, and/or any combination thereof (e.g. a processor, control unit/entity, controller) to execute instructions or software and control transmission and receptions of signals, and a memory to store data and/or instructions.

The circuitry may also make decisions or determinations, generate frames, packets or messages for transmission, decode received frames or messages for further processing, and other tasks or functions described herein. The circuitry may control transmission of signals or messages over a radio network, and may control the reception of signals or messages, etc., via one or more communication networks.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

While aspects of the present disclosure have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present disclosure as determined based upon the claims and any equivalents thereof.

### LIST OF ABBREVIATIONS

5G Fifth Generation
CCO Capacity and Coverage Optimization
DL Downlink
MDAS Management Data Analytics Service
MnS Management Service
NWDAF Network Data Analytics Function
OAM Operations, Administration and Management
PDU Protocol Data Unit
PRB Physical Resource Block
QoE Quality of Experience
QoS Quality of Service
SON Self-Organizing Network
RRC Radio Resource Control
SSB Synchronization Signal Block
SS-RSRP Secondary synchronization Signal Reference Signal Power
SS-RSRQ Secondary synchronization Signal Reference Signal Received Quality
UL Uplink

### EXAMPLES

### 5 Use Cases, Potential Requirements and Possible Solutions

### 5.A AI/ML Activation

### 5.A.1 Description

TR 28.908 defines the AI/ML deployment as a process of making an AI/ML-enabled function available in the operational environments. After the training, the AI/ML-enabled function could be deployed in 3GPP system and subsequently activated. The current description for AI/ML entity activation assumes that the consumer requests and the producer executes activation of already deployed AI/ML entity and that the activation of AI/ML capabilities will unconditionally improve the network performance. This may not always be the case.

### 5.A.2 Use Cases

### 5.A.2.1 Enabling Gradual Activation of AI/ML Capabilities

For a given AI/ML-enabled function, first, It is very difficult to “predict” the benefits and to quantify such benefits of using AI/ML capability in a given context of operational network, before using it. Secondly, testing the AI/ML capabilities using test data does not give a “full picture” on how the AI/ML model will impact the network once it is activated in operational environment. For example, the testing may provide the insights on the accuracy of the AI/MLEntity that can be expected once the AI/MLEntity is deployed and activated.

As such it is necessary to ensure that AI/ML capabilities that are being activated in operational network will bring the benefits and will not further deepen existing network performance problems. Moreover, it is important to provide means to check which particular AI/ML capabilities are beneficial to be activated in a given context of operational network. Together, these imply that it is important to ensure that the AI/ML MnS consumer has a finer control on AI/ML capabilities activation and deactivation.

### 5.A.3 Potential Requirements

REQ-AI/MLUPDATE-1 the 3GPP management system shall have a capability to allow an authorized consumer to partially or gradually activate the AI/ML capabilities of a producer of AI/ML inference through set of abstract activation steps.
REQ-AI/MLUPDATE-2 the 3GPP management system shall have a capability to allow an authorized consumer to activate the AI/ML capabilities of an AI/ML inference producer for a specified subscope of the applicable expectedruntimecontext of the AI/ML inference producer.
REQ-AI/MLUPDATE-3 the 3GPP management system shall have a capability to allow an authorized consumer to partially or gradually deactivate the AI/ML capabilities of a producer of AI/ML inference through set of abstract activation steps.
REQ-AI/MLUPDATE-4 the 3GPP management system shall have a capability for the producer of AI/ML inference to inform an authorized consumer of the subscope for which the new AI/ML capabilities have been activated.

### 5.A.4 Possible Solutions

Note: the requirements above may be stated not on the the 3GPP management system but on the specific provider as follows:
REQ-AI/MLUPDATE-1 the producer of AI/ML inference shall have a capability to allow an authorized consumer to partially or gradually activate the AI/ML capabilities of the producer of AI/ML inference through set of abstract activation steps.
REQ-AI/MLUPDATE-2 the producer of AI/ML inference shall have a capability to allow an authorized consumer to activate the AI/ML capabilities of the AI/ML inference producer for a specified subscope of the applicable expectedruntimecontext of the AI/ML inference producer.
REQ-AI/MLUPDATE-3 the producer of AI/ML inference shall have a capability to allow an authorized consumer to partially or gradually deactivate the AI/ML capabilities of the producer of AI/ML inference through set of abstract activation steps.
REQ-AI/MLUPDATE-4 the provider of AI/ML inference shall have a capability for the producer of AI/ML inference to inform an authorized consumer of the subscope for which the new AI/ML capabilities have been activated.

1-44. (canceled)

45. A network device comprising at least one processor, at least one memory including computer program code, the at least one memory and computer program code configured to, with the at least one processor, cause the network device at least to perform:
obtaining information descriptive of a capability of a network entity of another network device, said network entity comprising a capability for providing an output based on an artificial intelligence and/or machine learning inference function related to one or more network objects or object types:
sending, to the other network device, a request for a partial activation of the capability.

46. The device of claim 45, wherein the at least one memory and the computer program are further configured, with the at least one processor, to cause the network device to perform obtaining information descriptive of a plurality of predefined ordered activation levels identifying gradually increasing capability activation scopes: and wherein the request describes the partial activation scope by reference to one of said predefined activation levels.

47. The device of one of the claim 45, wherein the at least one memory and the computer program are further configured, with the at least one processor, to cause the network device to perform receiving, from the other network device, information descriptive of a status of the activation scope of the capability in response to the request.

48. The device according to claim 45, wherein the information descriptive of the capability comprises one or more among the following items:
a. one or more objects and/or object types for which the network entity is configured to undertake optimization or control:
b. one or more parameters of the one or more objects and/or object types which the network entity is configured to control or optimize to achieve desired results:
c. one or more network metrics which the network entity is configured to seek improvement of:
d. one or more network characteristics related to the one or more objects and/or object types.

49. The device according to claim 48, wherein the request comprises one or more subsets of at least one of the items a to d for describing the partial scope of activation.

50. The device according to claim 45, wherein the request comprises at least one among a network context and an artificial intelligence and/or machine learning context for describing the partial activation scope.

51. The device according to claim 45, wherein the at least one memory and the computer program are further configured, with the at least one processor, to cause the network device to perform determining if data descriptive of a performance of the capability further to the activation of the capability at the requested activation scope meets a performance criterion, and in the affirmative, sending a request for an increase of the previously requested activation scope to the other network device.

52. The device according to claim 51, wherein the at least one memory and the computer program are further configured, with the at least one processor, to cause the network device to perform requesting an increase of the scope of activation of the capability only if a full scope of activation has not yet been reached.

53. The device according to claim 52, wherein the at least one memory and the computer program are further configured, with the at least one processor, to cause the network device to perform:
if the criterion is not met, sending a request for deactivation to the other network device identifying one of:
an instruction to undo the activation scope request:
a complete deactivation of the capability:
a reduced scope of activation to be achieved compared to the scope of activation for which the criterion was not met:
one or more parts of the activation scope of the capability that are to be deactivated:
a level among the plurality of predefined ordered activation levels identifying gradually increasing capability activation scopes of claim 2.

54. The device according to claim 45, wherein the at least one memory and the computer program are further configured, with the at least one processor, to cause the network device to perform determining network performance degradation and requesting a partial decrease in capability activation scope responsive to said determining.

55. The device according to claim 45, wherein the at least one memory and the computer program are further configured, with the at least one processor, to cause the network device to perform obtaining from the other network device at least one of an accuracy measurement or data descriptive of a benefit evaluation carried out by the other device, wherein said accuracy measurement or data descriptive of a benefit evaluation are function of an output of said capability for an envisioned partial activation scope without application of said output to an operational network environment and sending said request for partial activation as a function of the at least one of an accuracy measurement or data descriptive of a benefit evaluation.

56. A network device comprising at least one processor, at least one memory including computer program code, said network device comprising a network entity comprising a capability for providing an output based on an artificial intelligence and/or machine learning inference function related to one or more network objects or object types, the at least one memory and computer program code configured to, with the at least one processor, cause the network device at least to perform partial activation of the capability.

57. The device according to claim 56, wherein the at least one memory and the computer program are further configured, with the at least one processor, to cause the network device to perform making available, to other network devices, information descriptive of the capability.

58. The device according to claim 57, wherein the information descriptive of the capability comprises one or more among the following items:
a. one or more objects and/or object types for which the network entity is configured to undertake optimization or control:
b. one or more parameters of the one or more objects and/or object types which the network entity is configured to control or optimize to achieve desired results:
c. one or more network metrics which the network entity is configured to seek improvement of:
d. one or more network characteristics related to the one or more objects and/or object types.

59. The device according to claim 57, wherein the at least one memory and the computer program are further configured, with the at least one processor, to cause the network device to perform making available, to other network devices, information descriptive of a plurality of predefined ordered activation levels identifying gradually increasing capability activation scopes within the available scope.

60. The device according to claim 57, wherein the at least one memory and the computer program are further configured, with the at least one processor, to cause the network device to perform making available, to other network devices, at least one of an accuracy measurement or data descriptive of a benefit evaluation carried out by the other device, wherein said accuracy measurement or data descriptive of a benefit evaluation is function of an output of said capability for an envisioned change in activation scope without application of said output to an operational environment.

61. The device according to claim 56, wherein partial activation of the capability is performed in response to a request for partial activation from another network device.

62. The device according to claim 61, wherein the at least one memory and the computer program are further configured, with the at least one processor, to cause the network device to perform,
after activation of the capability at the requested scope, sending, to the other network device, status information descriptive of an activation status of the capability with regard to the requested scope.

63. The device according to claim 62, wherein the at least one memory and the computer program are further configured, with the at least one processor, to cause the network device to perform:
receiving, in the request, at least one among a network context and an artificial intelligence and/or machine learning context; and
responsive to the context, limiting the scope of activation of the capability.

64. The device according to claim 56, wherein the at least one memory and the computer program are further configured, with the at least one processor, to cause the network device to perform determining network performance degradation and partially decreasing the capability activation scope responsive to said determining.
